(19) United States
(12) Patent Application Publication
(10) Pub. No.: US 2021/0309928 A1
(43) Pub. Date: Oct. 7, 2021

(54) DURABLE LOW FRICTION COATING (DLFC) FOR BRAKE APPLICATION

(71) Applicant: Wolverine Advanced Materials, LLC, Dearborn, MI (US)

(72) Inventors: Abdul-Hafiz AFANEH, Dearborn, MI (US); Francesco MANCINA, Dearborn, MI (US); Abed HASHEMINASAB, Dearborn, MI (US)

(73) Assignee: Wolverine Advanced Materials, LLC, Dearborn, MI (US)

(21) Appl. No.: 16/840,241

(22) Filed: Apr. 3, 2020

(51) Int. Cl. C10M 107/44; C10M 107/32; C10M 113/00; C10M 113/08; F16D 65/00; F16D 65/095; F16D 65/097

(52) U.S. Cl. CPC C10M 107/44; C10M 107/32; C10M 113/00; C10M 113/08; F16D 65/0006; F16D 65/095; C10N 2040/08; C10M 2209/1013; C10M 2217/0453; C10M 2201/1013; C10M 2201/006; C10M 2201/0626; F16D 65/0977

(57) ABSTRACT

Technologies are described for a durable low friction coating (DLFC), which may be manufactured by mixing a binder, a filler, and one or more additives in liquid form, rolling the liquid mixture onto a coil material and curing for subsequent cutting and stamping. The DLFC may be used to coat an abutment clip or a brake shim directly onto a metal substrate or over an elastomer layer. Water-based binders may be used for environmentally friendly brake systems. In some examples, the binder in the DLFC may be in a range from at least 70 weight % to less than 95 weight %, the filler in a range from at least 1 weight % to less than 15 weight %, and the additives in a range from at least 0.2 weight % to less than 5 weight %.

### BACKGROUND

Unless otherwise indicated herein, the materials described in this section are not prior art to the claims in this application and are not admitted as prior art by inclusion in this section.

Low friction coatings provide improved performance and service life to machines and systems with moving parts while eliminating a need for wet lubricants in operating environments that require resistance to heat, chemicals, or clean room conditions. For example, U.S. Department of Energy data shows about one third of an automobile's fuel or electric energy consumption is spent overcoming friction which has a direct impact on emissions and fuel consumption efficiency.

Vehicles include brake discs for slowing the motion of the vehicle. These brake discs include a rotor that is affixed to a wheel of the vehicle. The brake disc rotor and the wheel are carried on a shaft, where the brake disc rotor rotates along with the wheel as it rotates. The brake disc rotor is disposed between a pair of calipers having brake pads mounted thereon. The brake pads are arranged to selectively engage the brake disc rotor to affect braking of the vehicle. In operation, pressure, such as hydraulic pressure, may be applied to the calipers, urging the calipers together until the brake disc rotor is squeezed under pressure between the pads, resulting in slowing or stopping of the vehicle. Abutment clips, which reside on a caliper bracket, create uniform surface for the brake pads. The abutment clips guide the brake pads to slide back and forth toward to the rotor. The sliding mechanism formed by the abutment clips may cause noise and vibration during the brake pad sliding.

### SUMMARY

According to some examples, a durable low friction coating (DLFC) for a brake system is described. The DLFC may include a binder in a range from at least 70 weight % to less than 95 weight %; a filler in a range from at least 1 weight % to less than 15 weight %, where the binder and the filler are mixed in liquid form; and one or more additives in a range from at least 0.2 weight % to less than 5 weight %, where the one or more additives are mixed with a liquid mixture of the binder and the filler in liquid form and the mixture of the binder, the filler, and the one or more additives are cured into a layer of DLFC.

According to other examples, the binder may include phenoxy in dry form, phenoxy in aqueous solution, polyurethane in dry form, polyurethane in aqueous solution form, melamine formaldehyde, bisphenol A epoxy, urea-formaldehyde, acrylate copolymer, or a combination thereof. The filler may include silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), or a combination thereof. The one or more additives may include an antifoam agent, a wetting agent, a dispersing agent, an emulsifier, a pigment, a surface modifier, an adhesion promoter, or a combination thereof.

According to further examples, a thickness of the layer of DLFC may be in a range from about 0.010 mm to about 0.025 mm. The layer of DLFC may be formed on a layer of elastomer and the layer of DLFC and the layer of elastomer are cured together. The layer of elastomer may include synthetic polyisoprene, polybutadiene, chloroprene rubber, polychloroprene, neoprene, butyl rubber, halogenated butyl rubber, styrene-butadiene rubber, nitrile rubber, hydrogenated nitrile rubber, or a combination thereof. A thickness of the layer of elastomer may be in a range from about 0.100 mm to about 0.150 mm.

According to other examples, a brake shim may include a metal substrate; two elastomer layers deposited on opposing surfaces of the metal substrate; an adhesive layer deposited on a surface of a first one of the two elastomer layers; and a durable low friction coating (DLFC) layer deposited on a surface of a second one of the two elastomer layers. The DLFC layer may include a binder in a range from at least 70 weight % to less than 95 weight %; a filler in a range from at least 1 weight % to less than 15 weight %, where the binder and the filler are mixed in liquid form; and one or more additives in a range from at least 0.2 weight % to less than 5 weight %, where the one or more additives are mixed with a liquid mixture of the binder and the filler in liquid form and the mixture of the binder, the filler, and the one or more additives are cured to form the DLFC layer.

According to some examples, a thickness of the metal substrate may be in a range from about 0.350 mm to about 0.400 mm, a thickness of the layer of elastomer may be in a range from about 0.100 mm to about 0.150 mm, and a thickness of the layer of DLFC may be in a range from about 0.010 mm to about 0.025 mm. The metal substrate may include stainless steel, nickel, nickel-aluminum alloy, iron-nickel-chromium-molybdenum alloy, or a combination thereof. The DLFC layer may be formed on the elastomer layer and the DLFC layer and the elastomer layer are cured together.

According to further examples, an abutment clip for a brake system is described. The abutment clip may include a metal substrate; an elastomer layers deposited on a first surface of the metal substrate; and two durable low friction coating (DLFC) layers. The first DLFC layer may be deposited on a surface of the elastomer layer and a second DLFC layer may be deposited on a second surface of the metal substrate. The first and second DLFC layers may include a binder in a range from at least 70 weight % to less than 95 weight %; a filler in a range from at least 1 weight % to less than 15 weight %, where the binder and the filler are mixed in liquid form; and one or more additives in a range from at least 0.2 weight % to less than 5 weight %, where the one or more additives are mixed with a liquid mixture of the binder and the filler in liquid form and the mixture of the binder, the filler, and the one or more additives are cured to form the first and second DLFC layers.

According to yet other examples, the first DLFC layer may be formed on the surface of the elastomer layer, and the first DLFC layer and the elastomer layer may be cured together, cut to shape, and stamped onto the first surface of the metal substrate. The cured second DLFC layer may be cut to shape and stamped onto the second surface of the metal substrate. The metal substrate may include stainless steel, nickel, nickel-aluminum alloy, iron-nickel-chromium-molybdenum alloy, or a combination thereof.

According to some examples, a method to manufacture a durable low friction coating (DLFC) for a brake system is described. The method may include mixing a binder and a filler in liquid form to form a first mixture; mixing the first mixture and an additive in liquid form to form a second mixture, where the binder is in a range from at least 70 weight % to less than 95 weight %, the filler in a range from at least 1 weight % to less than 15 weight %, and the additive is in a range from at least 0.2 weight % to less than 5 weight % in the second mixture; rolling the second mixture onto a coil material to form a layer of DLFC; and curing the layer of DLFC through heat treatment.

According to other examples, mixing the binder and the filler in liquid form to form the first mixture may include mixing phenoxy, polyurethane, melamine formaldehyde, bisphenol A epoxy, urea-formaldehyde, acrylate copolymer, or a combination thereof with silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), or a combination thereof in a water-based solvent; and mixing the first mixture and the additive in liquid form to form the second mixture may include mixing the first mixture with an antifoam agent, a wetting agent, a dispersing agent, an emulsifier, a pigment, a surface modifier, an adhesion promoter, or a combination thereof.

According to further examples, the method may further include rolling the second mixture onto an uncured layer of elastomer; and curing the layer of DLFC and the layer of elastomer together through heat treatment, where a thickness of the layer of DLFC is in a range from about 0.010 mm to about 0.025 mm, and a thickness of the layer of elastomer is in a range from about 0.100 mm to about 0.150 mm. Curing the layer of DLFC through heat treatment may include applying heated air, direct heat, or infrared heat to the layer of DLFC.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example brake disc assembly having a brake disc rotor and corresponding pair of brake pads;

FIG. 2A illustrates layers of an example metal substrate with dual elastomer layers and single DLFC;

FIG. 2B illustrates layers of an example metal substrate with single elastomer layer and dual DLFC;

FIG. 3A is a diagram illustrating an example brake shim coated with elastomer and DLFC layers;

FIG. 3B is a diagram illustrating an example abutment clip coated with elastomer and DLFC layers;

FIG. 4 is a diagram illustrating an example system for manufacturing example DLFC; FIG. 5 illustrates example result of durability and Taber abrasion tests on DLFC coated rubber substrates;

FIG. 6 is a diagram illustrating coefficient of friction (COF) and Taber abrasion test results for DLFC compounds with different fillers; and

FIG. 7 is a flow chart illustrating a method for preparing an example DLFC, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to durable low friction coatings (DLFCs) for brake applications, coated brake disc parts, and methods to produce DLFCs.

Briefly stated, a durable low friction coating (DLFC) may be manufactured by mixing a binder, a filler, and one or more additives in liquid form, rolling the liquid mixture onto a coil material and curing for subsequent cutting and stamping. The DLFC may be used to coat an abutment clip or a brake shim directly onto a metal substrate or over an elastomer layer. Water-based binders may be used for environmentally friendly chemicals. In some examples, the binder in the DLFC may be in a range from at least 70 weight % to less than 95 weight %, the filler in a range from at least 1 weight % to less than 15 weight %, and the additives in a range from at least 0.2 weight % to less than 5 weight %.

A DLFC layer according to examples may be applicable onto both on elastomer and metal layers (substrate). The DLFC is durable enough to be used in the brake insulators (shims) and abutment clips in automotive brake systems and have a low coefficient of friction. In addition, through the use of water-based binders, the coating may be environmentally friendly. The coating may lend itself to an easy and affordable production (e.g., transfer, mixing, and curing steps). It may also be applicable for roll/coil coating processes.

Elastomer (rubber) coated materials (RCM) are used for making shims. These parts reduce or eliminate the noises and vibration characteristics of some brake systems. The DLFC coated on nitrile rubber (NBR) may provide decoupling effect between pad and caliper which is desirable condition to minimize the noise and vibration. Furthermore, DLFC may provide better pad loading in anchor bracket.

Abutment clip materials coated with DLFC provide an effective sustainable sliding mechanism for the pads that minimize or eliminate the noise and vibration occurs during the pad sliding. DLFC may improve drag results through the low COF coating with its high durability and sustainability against friction. A RCM clip coated by DLFC may reduce the noise signature in all directions, making them a cost-effective alternative to a change in anchor bracket design. The RCM clip coated by DLFC may also help with filling in tolerance for a better ear-to-bracket alignment in a pad-back ear design. The RCM clip coated by DLFC may damp noises during braking more effectively in an in-plane vibration direction. A liquid form DLFC material (pre-cure) may have an expected shelf life of about 6-12 months. The expected life may be about 3-5 years on RCM cured materials.

By eliminating or minimizing the organic volatile content (VOC) in water-based systems, an environmentally friendly material may be achieved. By controlling the heat-based curing and coil and roller coating processes, the wet and dry film thickness may be easily controlled. Because of the cured layer end product, shims and clips may be easily stamped and produced from the DLFC coated material without further post-treatment.

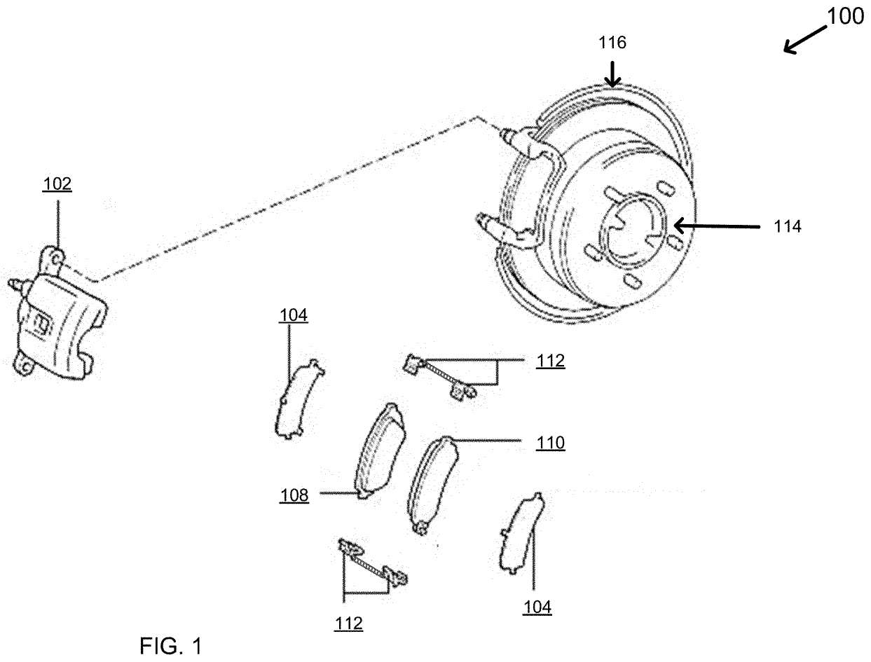

FIG. 1 illustrates an example brake disc assembly having a brake disc rotor and corresponding pair of brake pads arranged according to aspects of the present disclosure. The example brake disc assembly 100 includes a caliper 102, a pair of brake shims 104, an inner brake pad 108, an outer brake pad 110, abutment clips 112, a hub 114, and a brake disc rotor 116.

The hub 114 may be mounted on an axle (not shown). The brake disc rotor 116 has a disc shape and is a part of the hub 114. The brake disc rotor 116 is configured to rotate along with the hub 114 through the axle. When pressure is applied to a brake pedal of a vehicle, various systems in the vehicle will responsively actuate the caliper 102 to urge the surface of the inner and outer brake pads against a surface of the brake disc rotor 116, thus bringing the vehicle to a halt. The abutment clips 112 guide the brake pads to slide back and forth toward to the rotor. A low friction coating may be applied on the surface(s) of the shims 104 and abutment clips 112 to reduce noise and vibration that may occur during brake application. The DLFC may be applied directly to the metal substrate of the shims 104 or the abutment clips 112, or it may be applied onto an elastomer layer applied to the metal substrate of the shims 104 or the abutment clips 112. The DLFC may be composed of water- or solvent-based binder in a range from at least 70 weight % to less than 95 weight %, a filler in a range from at least 1 weight % to less than 15 weight %, and an additive in a range from at least 0.2 weight % to less than 5 weight %. The DLFC may be formed in liquid form, cured as a layer, and stamped onto the substrate.

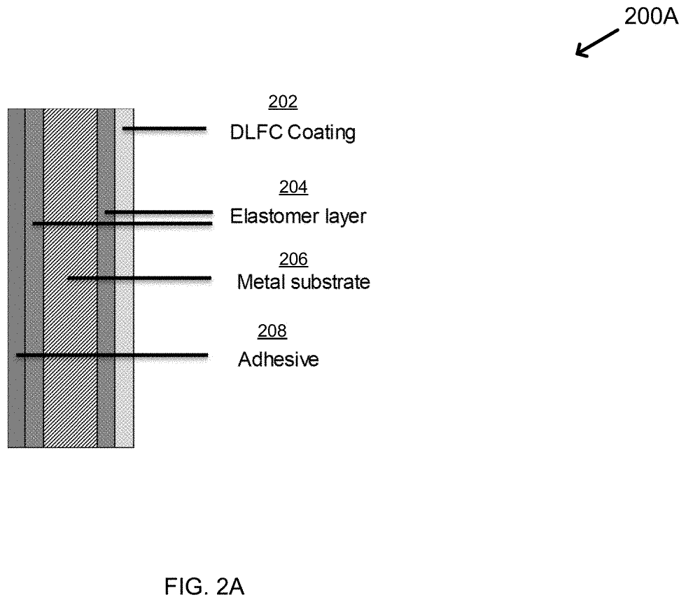

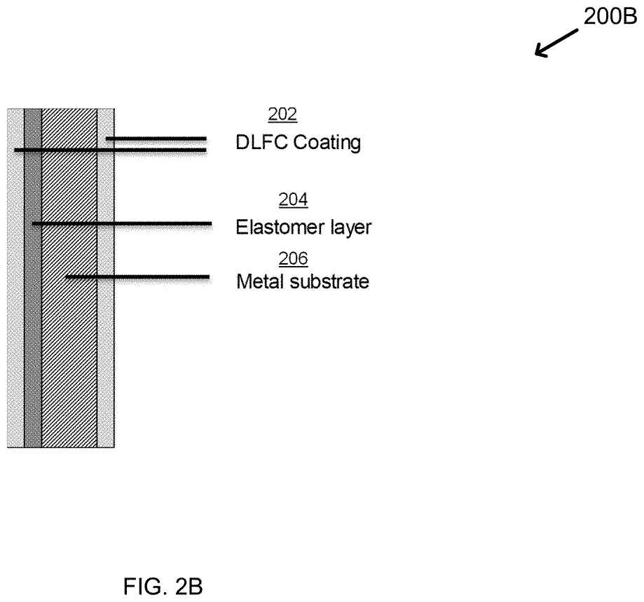

FIG. 2A illustrates layers of an example metal substrate with dual elastomer layers and single DLFC, arranged according to aspects of the present disclosure. The coated substrate 200A includes metal substrate 206 coated with elastomer layers 204 on opposite surfaces, a DLFC layer 202 on one of the elastomer layers 204, and an adhesive layer 208 on the other one of the elastomer layers 204.

The metal substrate 206 may include stainless steel, nickel, nickel-aluminum alloy, iron-nickel-chromium-molybdenum alloy, or similar metal materials. Elastomer layers 204 may be applied for vibration and noise reduction. The elastomer layers 204 may include a polymer with viscoelasticity (i.e., both viscosity and elasticity) and weak intermolecular forces. Examples of elastomer that may be used in the elastomer layers 204 may include, but are not limited to, synthetic polyisoprene, polybutadiene, chloroprene rubber, polychloroprene, neoprene, butyl rubber (copolymer of isobutylene and isoprene), halogenated butyl rubbers (chloro-butyl rubber, bromo-butyl rubber), styrene-butadiene rubber, nitrile rubber, and/or hydrogenated nitrile rubbers. In the illustrated example, adhesive layer 208 is applied to one of the elastomer layers 204, for example, to attach the shim to the brake pad. The opposing elastomer layer 204 may be coated with DLFC 206, which as discussed above, may be composed of a binder in a range from at least 70 weight % to less than 95 weight %, a filler in a range from at least 1 weight % to less than 15 weight %, and an additive in a range from at least 0.2 weight % to less than 5 weight %.

The DLFC layer 206 may be applied to an outer surface of the shim 104 in FIG. 1 formed by the metal substrate 206, for example, to reduce friction with inner surfaces of the caliper as the brake pads are moved.

FIG. 2B illustrates layers of an example metal substrate with single elastomer layer and dual DLFC arranged according to aspects of the present disclosure. The coated substrate 200B includes metal substrate 206 coated with elastomer layer 204 on one surface and DLFC layers 202 on opposing surfaces. One of the DLFC layers 202 may be deposited onto the elastomer layer 204, and the other DLFC layer 204 may be applied directly onto an opposite surface of the metal substrate 206.

In some examples, the binder in the DLFC layer 202 may include, but is not limited to, phenoxy (in dry or aqueous solution form), polyurethane (in dry or aqueous solution form), melamine formaldehyde, bisphenol A epoxy, urea-formaldehyde, acrylate copolymer, and/or combinations thereof. The filler in the DLFC layer 202 may include, but is not limited to, silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), and/or combinations thereof. The additives in the DLFC layer 202 may include, but is not limited to, antifoam agents, wetting agents, dispersing agents, emulsifiers, pigments, surface modifiers (e.g., hydrocarbon surfactants), adhesion promoters (e.g. silanes, titanates, etc.), and/or combinations thereof. It should be noted that the DLFC layer 202 may be produced by combining one or more of any of binders, fillers, and additives listed above or similar materials. For example, phenoxy as binder may be combined with two (or more) fillers and three or more additives. Similarly, two binders may be combined with one filler, etc.

According to some examples, a thickness of the DLFC layer 202 may be in a range from about 0.010 mm to about 0.025 mm. A thickness of the elastomer layer 204 may be in a range from about 0.100 mm to about 0.150 mm. A thickness of the metal substrate may be in a range from about 0.350 mm to about 0.400 mm.

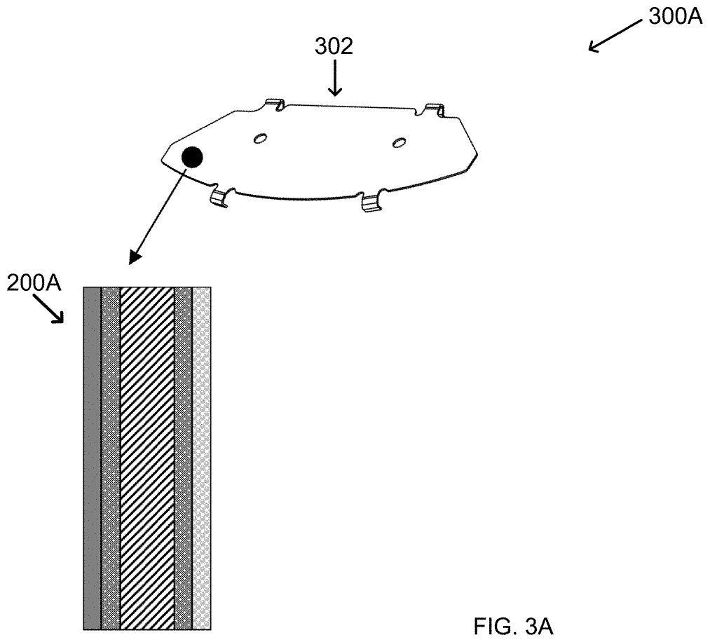

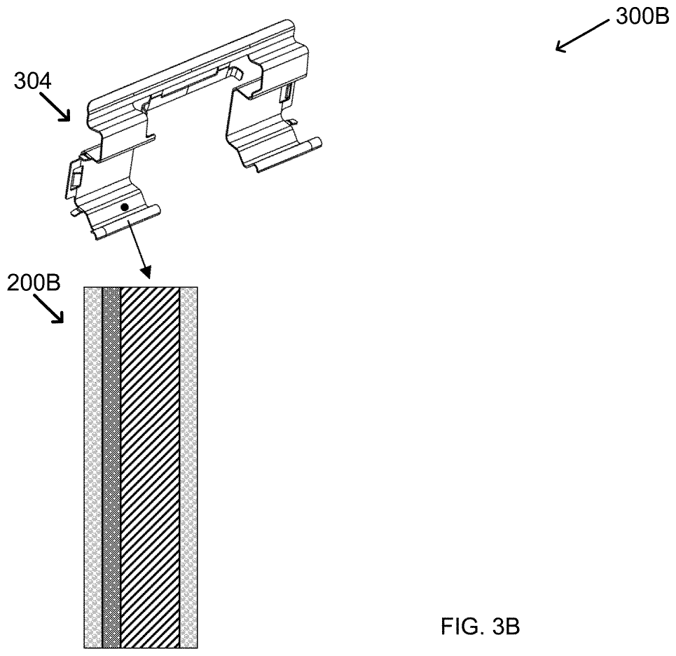

FIG. 3A is a diagram illustrating an example brake shim coated with elastomer and DLFC layers arranged according to aspects of the present disclosure.

As shown in diagram 300A, coated substrate 200A may be used as shim 302, where the shim may be formed from the metal substrate 206 and the elastomer and DLFC layers stamped onto the metal substrate. The adhesive layer of the coated substrate 200A may be used to attach the shim 302 to a brake pad such that the DLFC layer faces the caliper and provides noise and vibration reduction when the parts move in an operation.

FIG. 3B is a diagram illustrating an example abutment clip coated with elastomer and DLFC layers arranged according to aspects of the present disclosure.

As shown in diagram 300B, coated substrate 200B may be used as abutment clip 304, where the abutment clip may be formed from the metal substrate 206 and the elastomer and DLFC layers stamped onto the metal substrate. One surface of the metal substrate may be treated with the DLFC layer and the opposing surface of the metal substrate may be treated with elastomer and DLFC layers such that the abutment clip 304 provides noise and vibration reduction when the parts move in an operation.

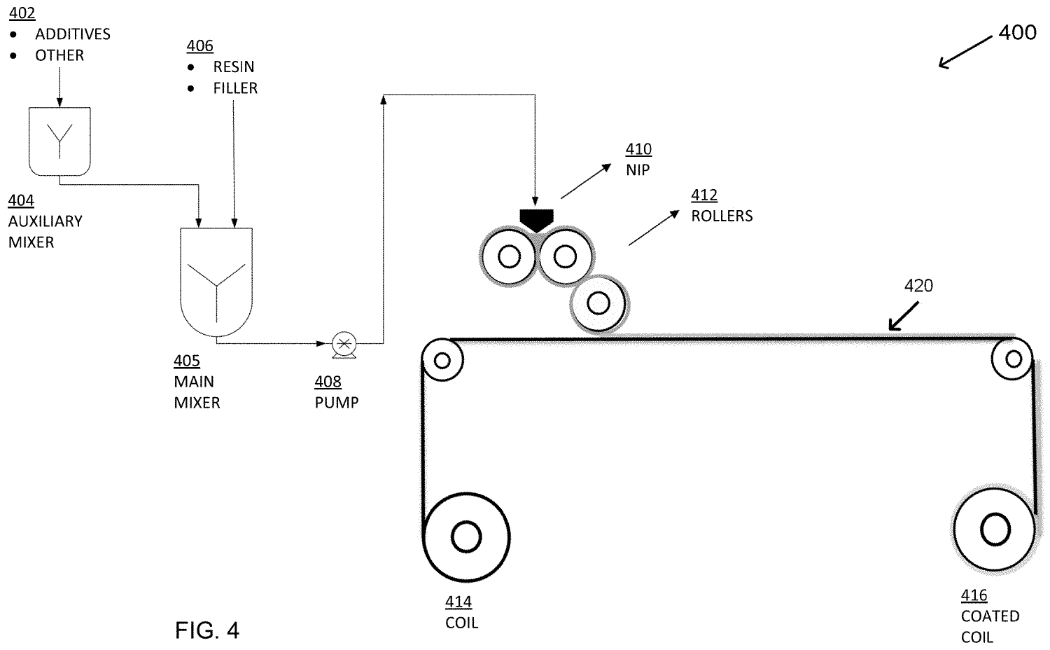

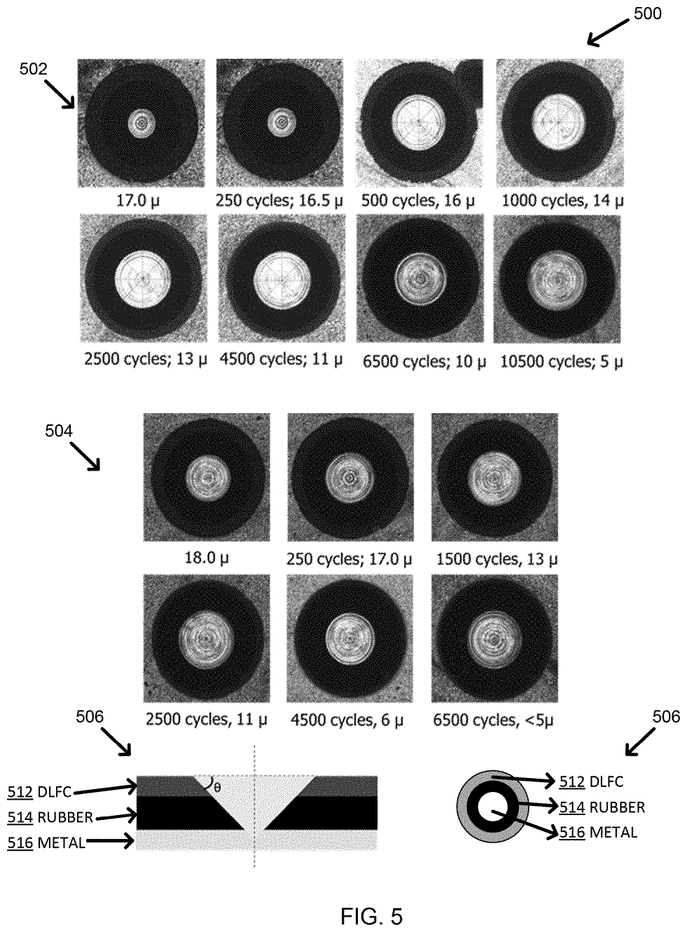

FIG. 4 is a diagram illustrating an example system for manufacturing example DLFC arranged according to aspects of the present disclosure.

As shown in diagram 400, an example system may include an auxiliary mixer 404 to mix additives and solvents 402, a main mixer 405 to mix binders and fillers 406, a pump 408, a nip 410 to catch the liquid mixture and provide to rollers 412, which coat a rolling coil material 414 with the mixture, and the mixture is cured as a layer 420 on the coil material 414 resulting in the coated coil material 416.

In an example operation, a binder, for example, phenoxy (in dry or aqueous solution form), polyurethane (in dry or aqueous solution form), melamine formaldehyde, bisphenol A epoxy, urea-formaldehyde, acrylate copolymer, and/or combinations thereof, and a filler, for example, silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), and/or combinations thereof, may be mixed in the main mixer 405. Other additives such as antifoam agents, wetting agents, dispersing agents, emulsifiers, pigments, surface modifiers (e.g., hydrocarbon surfactants), adhesion promoters (e.g. silanes, titanates, etc.), and/or combinations thereof, may be pre-mixed in auxiliary mixer 404. As mentioned above, combinations of multiple materials such as two binders and three fillers, one binder and two fillers, etc. may be mixed too. The final mixture may be provided by a pump 408 to the rollers 412, which may apply the mixture as a layer onto coil material 414. The layer of DLFC may be cured through thermal treatment such as hot air, infrared light, convection heating, or other thermal mechanisms.

The cured layer of DLFC may be removed from the coated coil material 416, cut to shape and stamped onto preformed metal substrates in form of a shim or an abutment clip. In other examples, the liquid DLFC layer may be applied to the metal substrates and cured on the metal substrates too. In case of elastomer and DLFC layer combinations, the elastomer layer and the DLFC layer may be cured together providing enhanced durability and cost efficiency. A thickness of the DLFC layer 202 may be in a range from about 0.010 mm to about 0.025 mm.

FIG. 5 illustrates example result of durability and Taber abrasion tests on DLFC coated rubber substrates arranged according to aspects of the present disclosure.

Diagram 500 includes pictures of a test disc after a predefined number of test cycles with filler 1 used in the DLFC (502), pictures of another test disc after a predefined number of test cycles with filler 2 used in the DLFC (504), and cross-sectional diagrams 506 showing layers of the test discs, metal layer 516, elastomer (rubber) layer 514, and DLFC layer 512. Fillers 1 and 2 are SiC in different size domains.

Taber abrasion is a test to determine a material's resistance to abrasion. Resistance to abrasion is defined as the ability of the material to withstand mechanical action such as rubbing, scraping, or erosion. Three forms of abrasion occur and are tested for, namely flat (plane or surface) abrasion, edge abrasion (i.e. at collars and folds) and flex (flexing and bending) abrasion. Durability may be measured as period of time (in operational life) or number of operational cycles. The pictures 502 and 504 for two different fillers show abrasion depth after a number of simulated operational cycles. For example, in pictures 502 for filler 1, the test disc starts with a thickness of 17.0 μm. The abrasion depth starts with 0.5 μm at 250 cycles and increases gradually to 12.0 μm after 10500 cycles. The test disc for filler 2 starts with a thickness of 18.0 μm. The abrasion depth starts with 1.0 μm at 250 cycles and increases gradually to more than 16.0 μm after 6500 cycles. Thus, filler 1 provides a more durable DLFC layer compared to filler 2.

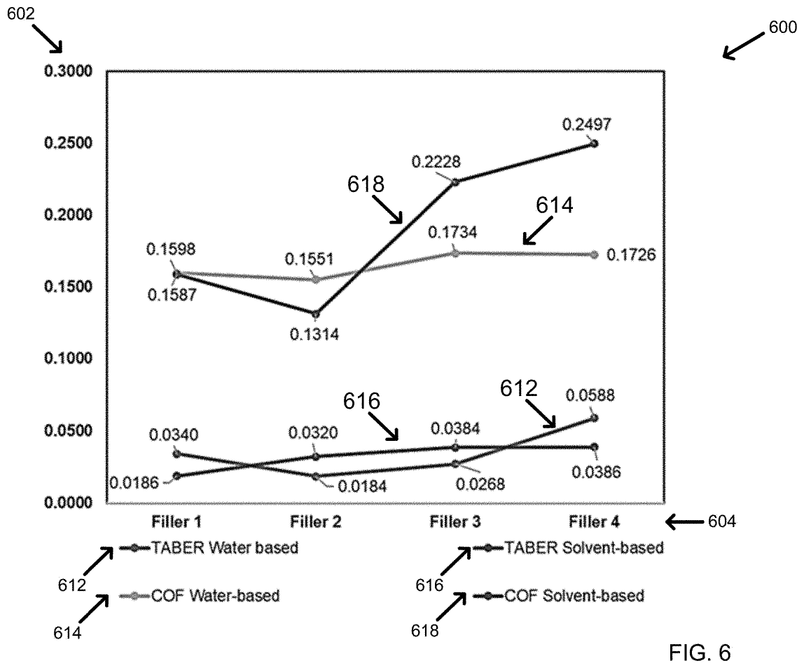

FIG. 6 is a diagram illustrating coefficient of friction (COF) and Taber abrasion test results for DLFC compounds with different fillers arranged according to aspects of the present disclosure.

Diagram 600 includes a graph, where the vertical axis 602 represents Taber mass loss values in mg/cycle and coefficient of friction (COF) values. Measured values of mass loss and COF are shown as plots 612, 614, 616, and 618 along horizontal axis 604. Plot 612 represents Taber mass loss values for a solvent-based system for four different fillers (fillers 1, 2, 3, and 4) in the DLFC. Plot 616 represents Taber mass loss values for a water-based system for the same four fillers (fillers 1, 2, 3, and 4) in the DLFC. While there are some differences in the Taber mass loss values for the same fillers, the plots 612, 616 indicate solvent- and water-based systems according to examples have similar abrasion results. Thus, environment-friendly water-based systems may be used in addition to the enhancements in durability. Fillers 1 and 2 are SiC in different size domains. Fillers 3 and 4 are Al₂O₃ in different size domains.

Plot 614 represents COF values for a water-based system for the same four fillers as above (fillers 1, 2, 3, and 4) in the DLFC. Plot 618 represents COF values for a solvent-based system for the same four fillers (fillers 1, 2, 3, and 4) in the DLFC. Plots 614 and 618 showing differences between water- and solvent-based systems also indicate similar (in case of filler 1, very similar) coefficients of friction may be achieved by using an environment-friendly water-based system instead of a solvent-based system with the exception of filler 4, where the solvent-based system achieves a higher COF value.

In another battery of tests, a shim with and without DLFC layer has been subjected to dynamometer noise test. The tests show that a stainless steel shim without DLFC has 1.4%Occur at 70 dBA and 0.8%Occur at 80 dBA, whereas a shim with DLFC coating showed 0.5%Occur at 70 dBA and 0.1%Occur at 80 dBA. The thickness of the DLFC layer in the test was about 0.018 mm. In another dynamometer test, maximum noise level (dBA) for a shim without DLFC layer was observed to concentrate at about 10.700 MHz, whereas the maximum noise level for the shim with DLFC layer did not show a concentration.

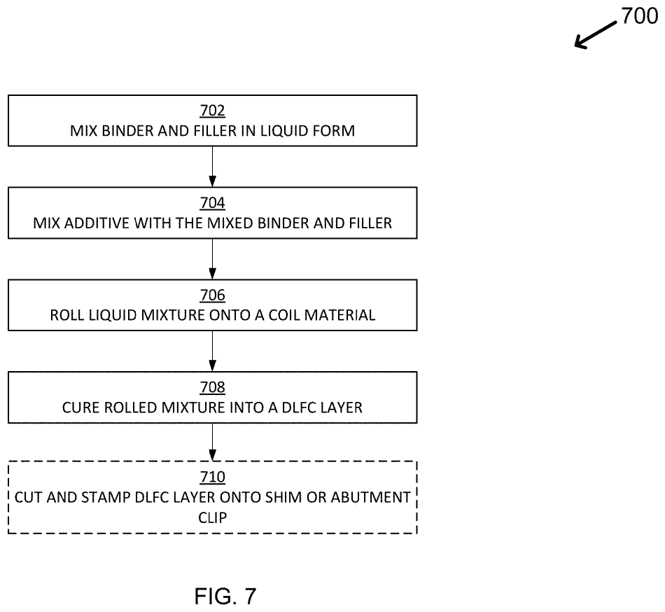

FIG. 7 is a flow chart illustrating a method for preparing an example DLFC arranged according to aspects of the present disclosure.

The described method 700, may include block 702, “MIX BINDER AND FILLER IN LIQUID FORM”, block 704, “MIX ADDITIVE WITH THE MIXED BINDER AND FILLER”, block 706, “ROLL LIQUID MIXTURE ONTO A COIL MATERIAL”, block 708, “CURE ROLLED MIXTURE INTO A DLFC LAYER”, and optional block 710, “CUT AND STAMP DLFC LAYER ONTO SHIM OR ABUTMENT CLIP.” At block 702, a binder such as phenoxy, polyurethane, melamine formaldehyde, bisphenol A epoxy, urea-formaldehyde, or acrylate copolymer, and a filler such as silicon carbide, (SiC), aluminum oxide (Al₂O₃), boron nitride (BN), nano-silica, polytetrafluoroethylene (PTFE), graphene, molybdenum disulfide (MoS₂), or titanium dioxide (TiO₂), may be mixed with a solvent. The liquid mixture from block 702 may be mixed with an additive such as an antifoam agent, a wetting agent, a dispersing agent, an emulsifier, a pigment, a surface modifier, or an adhesion promoter in liquid form.

The liquid mixture from block 704 may be rolled onto a coil material to form a layer at block 706 and cured through heat treatment at block 708, for example, through application of heated air, direct heat, infrared heat, and similar ones. The cured DLFC layer material may be cut and stamped onto a shim or abutment clip at optional block 710. In case of elastomer and DLFC combination layers, the elastomer layer and the DLFC layer may be cured together providing additional durability and cost effectiveness.

### EXAMPLES

The following examples are intended as illustrative and non-limiting and represent specific embodiments of the present disclosure. The examples show that the disclosed coatings have a low coefficient of friction, high durability, and ease of manufacturing.

### Example 1

An aqueous solution of phenoxy is mixed with SiC filler and boron nitride (BN) filler. The liquid mixture is mixed with a hydrocarbon surfactant and a silane additive. The still liquid mixture is rolled over a stainless steel substrate of 0.400 mm thickness as a layer with a thickness of 0.015 mm. The DLFC layer is cured at 400° C. degrees. Next, a liquid NBR layer of 0.12 mm thickness is applied to the opposite surface of the stainless steel substrate followed by a second DLFC layer of 0.015 mm thickness. The second DLFC layer and the elastomer layer are cured together at 400° C. degrees. The stainless steel substrate with both surfaces treated is cut to shape to form brake shims.

### Example 2

An aqueous solution of polyurethane is mixed with Al₂O₃ and the mixture further mixed with an antifoam agent and a wetting agent. The liquid mixture is rolled on a coil substrate and cured under infrared light to form a DLFC layer of 0.016 mm thickness. The cured DLFC layer is subsequently cut to shape and stamped onto abutment clips.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A durable low friction coating (DLFC) for a brake system, the DLFC comprising:
a binder in a range from at least 70 weight % to less than 95 weight %;
a filler in a range from at least 1 weight % to less than 15 weight %, wherein the binder and the filler are mixed in liquid form; and
one or more additives in a range from at least 0.2 weight % to less than 5 weight %, wherein the one or more additives are mixed with a liquid mixture of the binder and the filler in liquid form and the mixture of the binder, the filler, and the one or more additives are cured into a layer of DLFC.

2. The DLFC of claim 1, wherein the binder comprises phenoxy in dry form, phenoxy in aqueous solution, polyurethane in dry form, polyurethane in aqueous solution form, melamine formaldehyde, bisphenol A epoxy, urea-formaldehyde, acrylate copolymer, or a combination thereof.

3. The DLFC of claim 1, wherein the filler comprises silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), or a combination thereof.

4. The DLFC of claim 1, wherein the one or more additives comprise an antifoam agent, a wetting agent, a dispersing agent, an emulsifier, a pigment, a surface modifier, an adhesion promoter, or a combination thereof.

5. The DLFC of claim 1, wherein a thickness of the layer of DLFC is in a range from about 0.010 mm to about 0.025 mm.

6. The DLFC of claim 1, wherein the layer of DLFC is formed on a layer of elastomer and the layer of DLFC and the layer of elastomer are cured together.

7. The DLFC of claim 6, wherein the layer of elastomer comprises synthetic polyisoprene, polybutadiene, chloroprene rubber, polychloroprene, neoprene, butyl rubber, halogenated butyl rubber, styrene-butadiene rubber, nitrile rubber, hydrogenated nitrile rubber, or a combination thereof.

8. The DLFC of claim 6, wherein a thickness of the layer of elastomer is in a range from about 0.100 mm to about 0.150 mm.

9. A brake shim comprising:
a metal substrate;
two elastomer layers deposited on opposing surfaces of the metal substrate;
an adhesive layer deposited on a surface of a first one of the two elastomer layers; and
a durable low friction coating (DLFC) layer deposited on a surface of a second one of the two elastomer layers, wherein the DLFC layer comprises:
a binder in a range from at least 70 weight % to less than 95 weight %;
a filler in a range from at least 1 weight % to less than 15 weight %, wherein the binder and the filler are mixed in liquid form; and
one or more additives in a range from at least 0.2 weight % to less than 5 weight %, wherein the one or more additives are mixed with a liquid mixture of the binder and the filler in liquid form and the mixture of the binder, the filler, and the one or more additives are cured to form the DLFC layer.

10. The brake shim of claim 9, wherein a thickness of the metal substrate is in a range from about 0.350 mm to about 0.400 mm, a thickness of the layer of elastomer is in a range from about 0.100 mm to about 0.150 mm, and a thickness of the layer of DLFC is in a range from about 0.010 mm to about 0.025 mm.

11. The brake shim of claim 9, wherein the metal substrate comprises stainless steel, nickel, nickel-aluminum alloy, iron-nickel-chromium-molybdenum alloy, or a combination thereof.

12. The brake shim of claim 9, wherein the DLFC layer is formed on the elastomer layer and the DLFC layer and the elastomer layer are cured together.

13. An abutment clip for a brake system, the abutment clip comprising:
a metal substrate;
an elastomer layers deposited on a first surface of the metal substrate; and
two durable low friction coating (DLFC) layers, wherein
a first DLFC layer is deposited on a surface of the elastomer layer,
a second DLFC layer is deposited on a second surface of the metal substrate, and the first and second DLFC layers comprise:
a binder in a range from at least 70 weight % to less than 95 weight %;
a filler in a range from at least 1 weight % to less than 15 weight %, wherein the binder and the filler are mixed in liquid form; and
one or more additives in a range from at least 0.2 weight % to less than 5 weight %, wherein the one or more additives are mixed with a liquid mixture of the binder and the filler in liquid form and the mixture of the binder, the filler, and the one or more additives are cured to form the first and second DLFC layers.

14. The abutment clip of claim 13, wherein
the first DLFC layer is formed on the surface of the elastomer layer, and
the first DLFC layer and the elastomer layer are cured together, cut to shape, and stamped onto the first surface of the metal substrate.

15. The abutment clip of claim 13, wherein the cured second DLFC layer is cut to shape and stamped onto the second surface of the metal substrate.

16. The abutment clip of claim 13, wherein the metal substrate comprises stainless steel, nickel, nickel-aluminum alloy, iron-nickel-chromium-molybdenum alloy, or a combination thereof.

17. A method to manufacture a durable low friction coating (DLFC) for a brake system, the method comprising:
mixing a binder and a filler in liquid form to form a first mixture;
mixing the first mixture and an additive in liquid form to form a second mixture, wherein the binder is in a range from at least 70 weight % to less than 95 weight %, the filler in a range from at least 1 weight % to less than 15 weight %, and the additive is in a range from at least 0.2 weight % to less than 5 weight % in the second mixture;
rolling the second mixture onto a coil material to form a layer of DLFC; and
curing the layer of DLFC through heat treatment.

18. The method of claim 17, wherein
mixing the binder and the filler in liquid form to form the first mixture comprises:
mixing phenoxy, polyurethane, melamine formaldehyde, bisphenol A epoxy, urea-formaldehyde, acrylate copolymer, or a combination thereof with silicon carbide, (SiC), aluminum oxide (Al₂O₃), boron nitride (BN), nano-silica, polytetrafluoroethylene (PTFE), graphene, molybdenum disulfide (MoS₂), titanium dioxide (TiO₂), or a combination thereof in a water-based solvent; and
mixing the first mixture and the additive in liquid form to form the second mixture comprises:
mixing the first mixture with an antifoam agent, a wetting agent, a dispersing agent, an emulsifier, a pigment, a surface modifier, an adhesion promoter, or a combination thereof.

19. The method of claim 17, further comprising:
rolling the second mixture onto an uncured layer of elastomer; and
curing the layer of DLFC and the layer of elastomer together through heat treatment, wherein a thickness of the layer of DLFC is in a range from about 0.010 mm to about 0.025 mm, and a thickness of the layer of elastomer is in a range from about 0.100 mm to about 0.150 mm.

20. The method of claim 17, wherein curing the layer of DLFC through heat treatment comprises:
applying heated air, direct heat, or infrared heat to the layer of DLFC.
